(19) United States
(12) Patent Application Publication
(10) Pub. No.: US 2002/0198776 A1
(43) Pub. Date: Dec. 26, 2002

(54) Fitness tool, point-giving server, point-giving system, pointigiving method and program

(76) Inventors: Takashi Nara, Kanagawa (JP); Yoshinori Kondo, Tokyo (JP); Yuji Fukuchi, Kanagawa (JP); Yukio Mandokoro, Tokyo (JP)

Correspondence Address: John J. Penny, Jr., EDWARDS & ANGELL, LLP, P.O. Box 9169, Boston, MA, 02209, US

(21) Appl. No.: 10/087,329

(22) Filed: Mar. 1, 2002

(30) Foreign Application Priority Data
Mar. 5, 2001 (JP) 2001-59852
Sep. 20, 2001 (JP) 2001-286645

(51) Int. Cl. G06F 17/60; A63B 71/00; A63B 22/00

(52) U.S. Cl. 705/14; 482/8; 482/51

(57) ABSTRACT

A tool for allowing a user to take exercise, includes: an exercise amount measuring unit for measuring an exercise amount of the user; a data storing unit for storing a predetermined character string or image; and an output unit for outputting the predetermined character string or image stored in the data storing unit when the exercise amount measured by the exercise measuring unit has reached a predetermined exercise amount.

This patent application claims priority from a Japanese patent application Nos. 2001-59852 filed on Mar., 5, 2001 and 2001-286645 filed on Sep. 20, 2001, the contents of which are incorporated herein by reference.

### BACKGROUND OF THE INVENTION

1. Field of the Invention

The present invention relates to a fitness tool, a point-giving server, a point-giving system, a point-giving method and a program that can provide a service for giving mileage of an airline, giving points of a credit card or the like to a person who took exercise.

2. Description of the Related Art

The airline, credit card company or the like provides a service for giving a member who used a service provided by that company points in proportion to the using amount of the service.

On the other hand, makers provide various types of fitness tools because health consciousness has grown recently.

The continuous use of the fitness tool is effective in preserving health. However, it was difficult for the conventional fitness tool to promote continuous use.

### SUMMARY OF THE INVENTION

Therefore, it is an object of the present invention to provide a fitness tool, a point-giving server, a point-giving system, a point-giving method and a program, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a tool for allowing a user to take exercise, comprises: an exercise amount measuring unit operable to measure an exercise amount of the user; a data storing unit operable to store a predetermined character string or image; and an output unit operable to output the predetermined character string or image stored in the data storing unit when the exercise amount measured by the exercise amount measuring unit has reached a predetermined exercise amount.

The exercise using the tool may be repetitive exercise; the exercise amount measuring unit may count the number of times of the repetitive exercise as the exercise amount; and the output unit may output the predetermined character or image when the number counted by the exercise amount measuring unit has reached a predetermined number corresponding to the predetermined exercise amount.

The tool may further comprise an accumulated time measuring unit operable to measure an accumulated time after the tool was first used, wherein the output unit outputs the predetermined character string or image under a condition where the accumulated time until the exercise amount measured by the exercise amount measuring unit reaches the predetermined exercise amount is equal to less than a predetermined value.

The tool may further comprise an accumulated time measuring unit operable to measure an accumulated time that has passed after the tool was first used, wherein the data storing unit further stores a plurality of character strings or images to correspond to a plurality of accumulated times, and the output unit outputs, when the exercise amount measured by the exercise amount measuring unit has reached the predetermined exercise amount, one of the character strings or images corresponding to the accumulated time measured by the accumulated time measuring unit.

The tool may further comprise an exercise amount memory operable to store an accumulated exercise amount that is obtained by accumulating the measuring result of the exercise amount measuring unit, while the tool is not used, wherein the output unit outputs to the predetermined character string or image when a sum of an exercise amount of the user newly detected while the tool is used again and the accumulated exercise amount has reached the predetermined exercise amount.

The exercise amount memory may store the accumulated exercise amount for each of a plurality of users; a user identifying information acquiring unit may be further provided operable to acquire information identifying each of the plurality of users when the tool is used again; and the output unit may acquire and use the accumulated exercise amount corresponding to the user identifying information acquiring unit from the exercise amount memory.

The tool may further comprise: a user information acquiring unit operable to acquire user information related to the user; and a processing unit operable to process the character string or image by using the user information, wherein the output unit outputs the character string or image after being processed.

The tool may further comprise a user information acquiring unit operable to acquire user information related to the user, wherein the data storing unit further stores a plurality of character strings or images to correspond to a plurality of units of user information, and the output unit outputs one of the character strings or images corresponding to the user information acquired by the user information acquiring unit when the exercise amount measured by the exercise amount measuring unit has reached the predetermined exercise amount.

The tool may further comprise a user information acquiring unit operable to acquire user information related to the user, wherein the data storing unit further stores a plurality of character strings or images to correspond to a plurality of predetermined exercise amounts, respectively, and the output unit outputs, when the exercise amount measured by the exercise amount measuring unit has reached one of the predetermined exercise amounts, one of the character string or images that corresponds to one of the predetermined exercise amounts.

The tool may further comprise: an identifying information storing unit operable to store tool identifying information that individually identifies the tool; and a processing unit operable to process the character string or image by using the tool identifying information, wherein the output unit outputs the character string or image after being processed.

The tool may further comprise: an identifying information acquiring unit operable to acquire tool identifying information for individually identifying the tool from the outside of the tool; and a processing unit operable to process the character string or image by using the tool identifying information, wherein the output unit outputs the character string or image after being processed.

According to the second aspect of the present invention, a point-giving server for giving a user points, comprises: a data acquiring unit operable to acquire a character string or image; a converter operable to convert the character string or image acquired by the data acquiring unit to points by using a point converting table which makes the character string or image correspond to the points; and an output unit operable to output the points generated by the converter to increase points accumulated for the user.

The data acquiring unit may acquire a plurality of types of character strings or images; and the converting table may make combinations of the plurality of types of character strings or images to a plurality of points, respectively, and convert each of the combinations of the plurality of types of character strings or images to corresponding points.

According to the third aspect of the present invention, a point-giving system having a tool for allowing a user to take exercise and a point-giving server for giving the user points is provided. The tool includes: an exercise amount measuring unit operable to measure an exercise amount of the user; a data storing unit operable to store a predetermined character string or image; and an output unit operable to output the predetermined character string or image stored in the data storing unit when the exercise amount measured by the exercise amount measuring unit has reached a predetermined exercise amount. The point-giving server includes: a data acquiring unit operable to acquire information specifying the predetermined character string or image output by the output unit of the tool; a converter operable to identify the predetermined character string or image from the information acquired by the data acquiring unit by using a point converting table for making character strings or images to plural points, and to convert the predetermined character string or image to corresponding points; and an output unit operable to output the points generated by conversion by the converter to increase accumulated points for the user.

According to the fourth aspect of the present invention, a point-giving method for giving points to a user who used a tool, comprises: measuring an exercise amount of the user by the tool and outputting a predetermined character string or image by the tool when the measured exercise amount has reached a predetermined exercise amount; and acquiring by a point-giving server the predetermined character string or image output by the tool and outputting points corresponding to the predetermined character string or image thus acquired from the point-giving server to increase points accumulated for the user.

According to the fifth aspect of the present invention, a program embodied on computer-readable medium, for performing a procedure in accordance with an exercise amount of a user, comprises: an exercise amount measuring module operable to measure the exercise amount of the user; and an output module operable to read a predetermined character string or image stored in a data storing unit when the exercise amount thus measured has reached a predetermined exercise amount.

According to the sixth aspect of the present invention, a program embodied on computer-readable medium, for performing a point-giving procedure which gives points to a user, comprises: a data acquiring module operable to acquire a character string or image; a converting module operable to convert the character string or image acquired by the data acquiring module to points by using a point converting table which makes the character string or image correspond to the points; and an output module operable to output the points generated by conversion by the converting module to increase points accumulated for the user.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary structure of a point system according to the first embodiment of the present invention.

FIG. 2 shows an example of a serial number and a product ID.

FIG. 3 shows an exemplary structure of a fitness tool according to the first embodiment of the present invention.

FIG. 4 is a plan view of a pedometer as an example of the fitness tool according to the first embodiment of the present invention.

FIG. 5 shows an exemplary data structure of a data storing unit according to the first embodiment of the present invention.

FIG. 6 shows another exemplary data structure of a data storing unit according to the first embodiment of the present invention.

FIG. 7 shows an exemplary data structure of a user information storing unit according to the first embodiment of the present invention.

FIG. 8 shows an exemplary structure of a point-giving server according to the first embodiment of the present invention.

FIG. 9 shows an exemplary data structure of a user storing unit of the point-giving server according to the first embodiment of the present invention.

FIG. 10 shows another exemplary data structure of an acquired point storing unit of the point-giving server according to the first embodiment of the present invention.

FIG. 11 shows an exemplary data structure of a certifying table of the point-giving server according to the first embodiment of the present invention.

FIG. 12 is a flowchart showing an example of an operation of the entire point-giving system according to the first embodiment of the present invention.

FIG. 13 shows details of Step S160 in the flowchart in FIG. 12.

FIG. 14 shows details of Step S170 in the flowchart in FIG. 12.

FIG. 15 shows details of Step S200 in the flowchart in FIG. 12.

FIG. 16 shows an example of a homepage in a case where a character string or image is received through the homepage in Step S180 in the flowchart in FIG. 12.

FIG. 17 shows an exemplary hardware configuration of the fitness tool according to the first embodiment of the present invention.

FIG. 18 shows an exemplary hardware configuration of the point-giving server according to the first embodiment of the present invention.

FIG. 19 shows an exemplary structure of a point system according to the second embodiment of the present invention.

FIG. 20 is a flowchart showing an example of a procedure of the point system according to the second embodiment of the present invention.

FIG. 21 shows an appearance of the fitness tool according to the second embodiment of the present invention.

FIG. 22 is a block diagram of an internal structure of the fitness tool according to the second embodiment of the present invention.

FIG. 23 shows an exemplary display screen for allowing a user to transmit a request.

FIG. 24 shows an example of a serial number, product ID and password.

FIG. 25 is a flowchart of a certifying procedure in a management server according to the second embodiment of the present invention.

FIG. 26 shows a modified example of the fitness tool of the first embodiment.

FIG. 27 shows another modified example of the fitness tool of the first embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

(Embodiment 1)

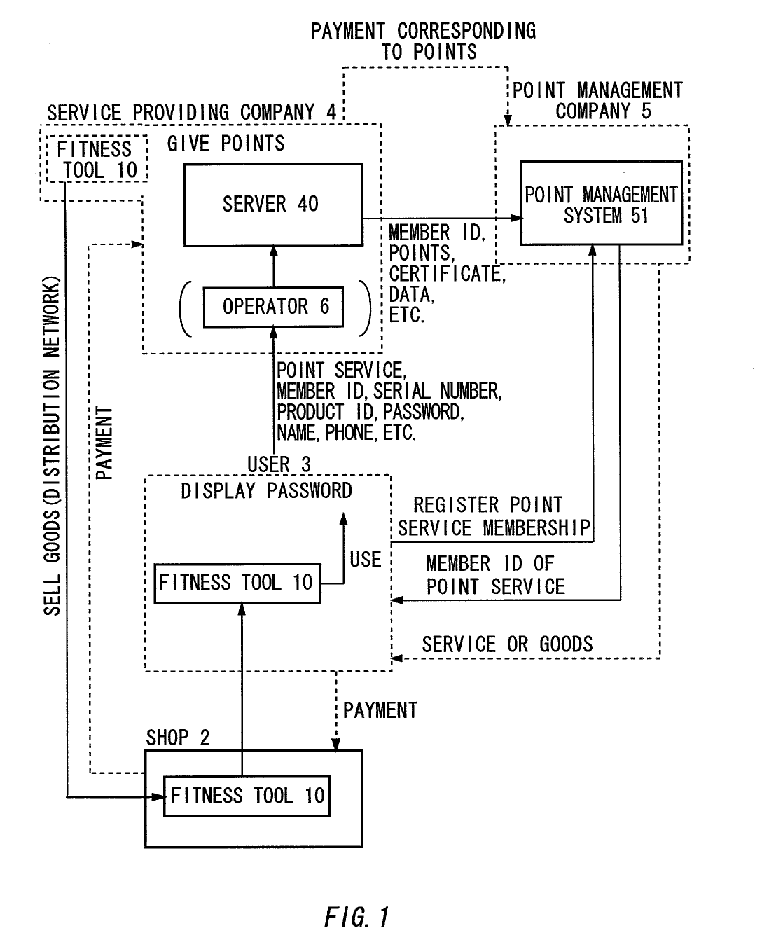

FIG. 1 schematically shows the structure of a point system according to the first embodiment of the present invention. The point system of the present embodiment is formed by a fitness tool 10 and a point-giving server 40. The point-giving server 40 communicates with a point management system 51, for example, via an exclusive line. The point-giving server 40 is managed by a service providing company 4. The point management system 51 is managed by a point management company 5 such as an airline or a credit card company.

In the present embodiment, the fitness tool 10 manufactured by the service providing company 4 or a company (and its associated company) cooperating with the service providing company 4 in the point system is sold through a distribution network to a shop 2. The shop 2 pays for the fitness tool 10 to the company (service providing company 4) from which the shop 2 bought the fitness tool 10. The price of the fitness tool 10 includes the cost required for the point service and therefore the service providing company 4 received the cost required for the point service when it sold the fitness tool 10. The shop 2 sells the fitness tool 10 at a price in which a predetermined profit is added to the price at which the shop 2 bought the fitness tool 10. A user 3 buys the fitness tool 10 from the shop 2. The user 3 may buy the fitness tool 10 via mail order or on-line shopping.

When the user 3 took exercise using the fitness tool 10 so that the exercise amount reached a predetermined exercise amount, the fitness tool 3 outputs a character string or an image, for example, a password. The user 3 inputs the character string or image output by the fitness tool 10 to the point-giving server 40 via a communication network such as the Internet or a telephone, or an operator 6. The user 3 may input information specifying the character string or image to the point-giving server 40, instead of inputting the character string or image itself. As such information, a name of the object indicated by the image or a Japanese word corresponding to the English word indicated by the character string can be considered.

The point-giving server 40 transmits the number of points corresponding to the acquired character string or image, or the number of points corresponding to the character string or image specified by the acquired information to the point management system 51 in order to provide the points to the user 3.

The point management system 51 adds the points received from the point-giving server 40 to the accumulated points for the user 3.

In the above service, since the service providing company 4 received the cost required for the point service at the time at which it sold the fitness tool 10, the point-giving server 40 pays the money corresponding to the points that the point-giving server 40 output to the point management system 51 to the point management company 5. This payment may be done at the time of the output of the points. Alternatively, the payment may be added up to be done on a fixed day of every month. Both the service providing company 4 and the point management company 5 commonly have data determining a conversion ratio between the points and the amount of money. Thus, the operation related to charging the cost is apparently defined.

The point-giving server 40 may have a function of calculating the amount of money corresponding to the output points. Moreover, the point management system 51 may have a function of calculating the amount of money corresponding to the received points.

An operating manual, an application sheet of point service membership and a certificate are attached to the fitness tool 10. The fitness tool 10 has a serial number 23 assigned thereto. In the certificate, the serial number 23 and a product ID 26 are written. The serial number 23 and the product ID 26 may be covered by a seal or silver coating until the user peels off the seal or silver coating after the user buys the fitness tool 10. The serial number 23 is an example of tool identifying information according to the present invention. The product ID 26 may be used as the tool identifying information.

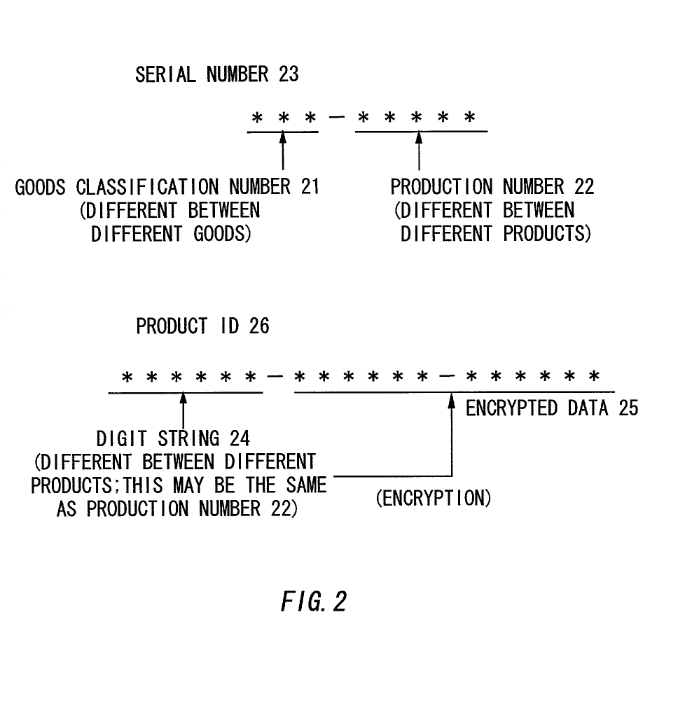

FIG. 2 shows an exemplary serial number 23 and an exemplary product ID 26. In the present embodiment, the serial number 23 is composed of a goods classification number 21 and a production number 22. The product ID 26 is composed of a digit string 24 (or a string of alphanumeric characters or a string of alphanumeric characters and symbols) that is different between the different products and an encrypted data stream 25 obtained by encrypting the digit string 24. The digit string 24 may be the same as the production number 22.

The user 3 inputs the following kinds of information to the point-giving server 40 as well as the character string or image.

(1) Point service member ID (acquired from the point management company 5)

(2) Serial number 23 (written on the fitness tool 10 and in the certificate 33)

(3) Product ID 26 (written in the certificate 33)

(4) Name, phone number and the like of the user 3 (to be used when it is necessary to make contact with the user 3)

The fitness tool 10 may transmit the character string or image and the above kinds of information directly to the point-giving server 40 via the communication network.

In a case where the user 3 inputs the character string or image to the point-giving server 40 via the operator 6, the user 3 provides the above kinds of information to the operator 6 or an automated reception system.

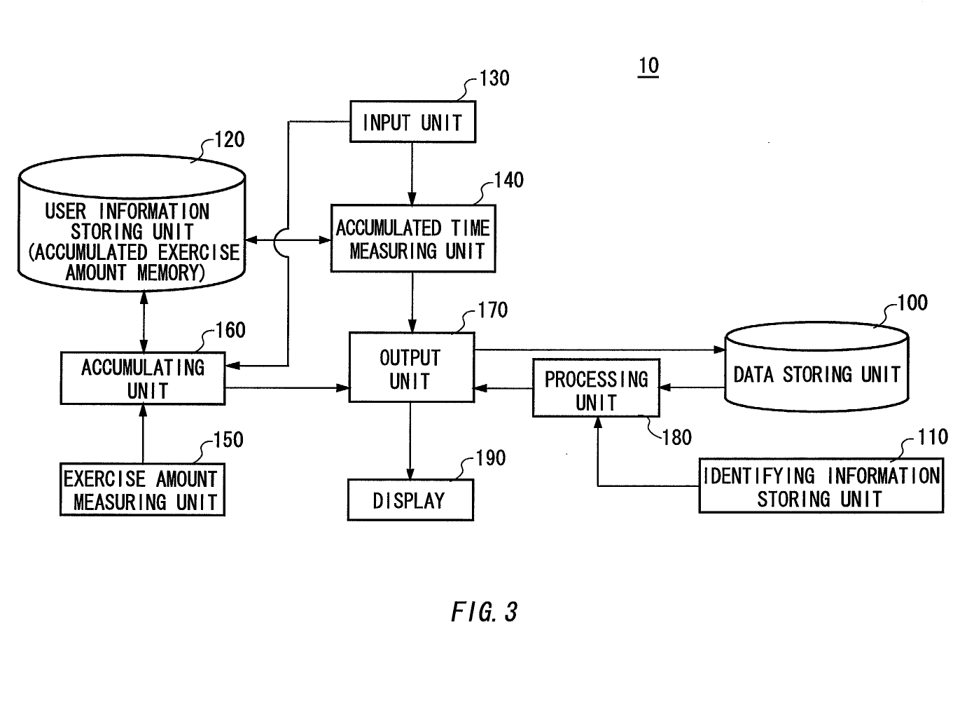

FIG. 3 shows an exemplary structure of the fitness tool 10. In the shown example, the fitness tool 10 includes an information storing part and a functional part. The information storing part includes a data storing unit 100, an identifying information storing unit 110 and a user information storing unit 120. The functional part includes an input unit 130, an accumulated time measuring unit 140, an exercise amount measuring unit 150, an accumulating unit 160, an output unit 170, a processing unit 180 and a display 190. The user information storing unit 120 is an example of an accumulated exercise memory according to the present invention.

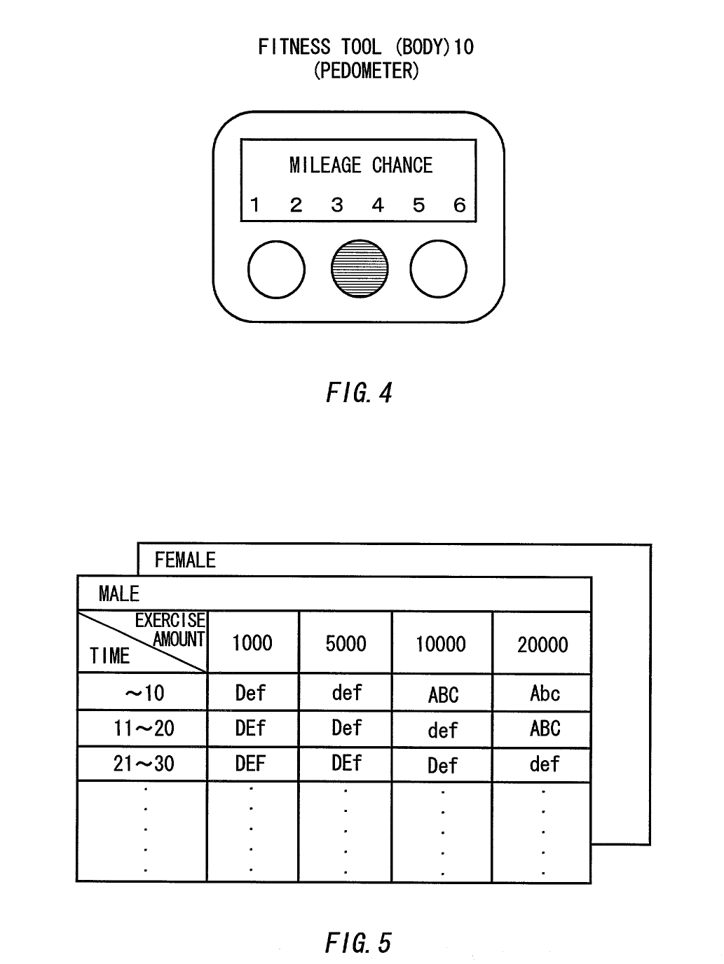

The fitness tool 10 is, for example, a pedometer as shown in FIG. 4. However, the fitness tool 10 may be a stepper, a dumbbell, a twister, a rope for jumping rope, a popping, an exercise bike, a walker or a party game requiring the player's movement. In the present embodiment, the fitness tool 10 can be used by a plurality of users.

The data storing unit 100 stores the character string or image output by the fitness tool 10.

FIG. 5 shows exemplary data structure of the data storing unit 100. In the shown example, the data storing unit 100 has a table for each sex. Each table stores character strings in the form of a matrix having the accumulated exercise amounts as the column and the accumulated times as the row. By using the data storing unit 100 as shown in FIG. 5, the fitness tool 10 can select and output the character string or image corresponding to the sex, the accumulated exercise amount and the accumulated time that are examples of the user information.

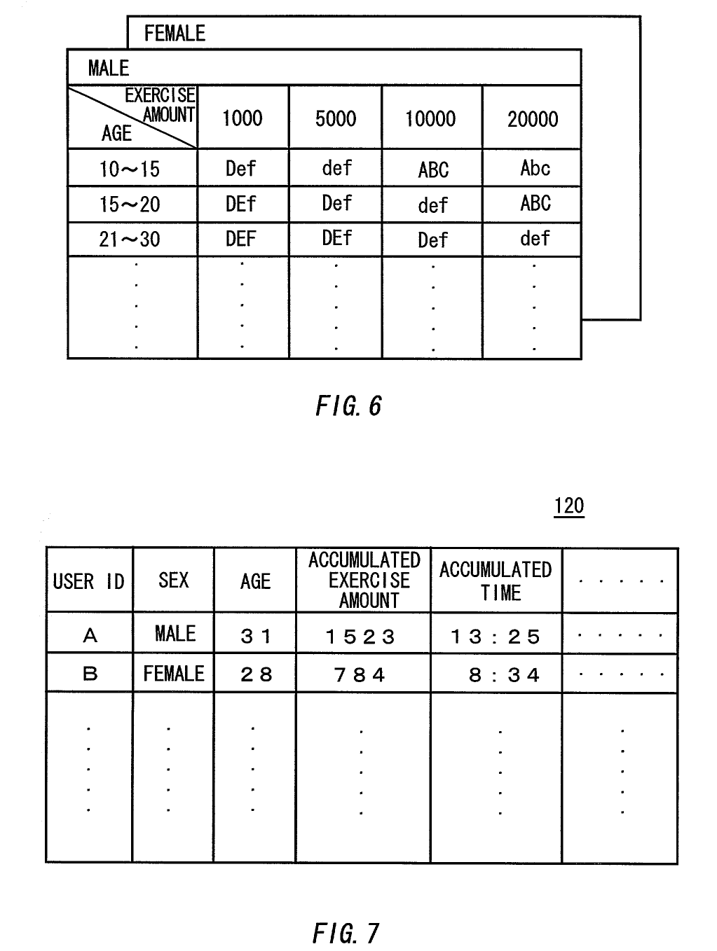

FIG. 6 shows another exemplary data structure of the data storing unit 100. In the shown example, the data storing unit 100 is approximately the same as the structure of the data storing unit 100 shown in FIG. 5. However, in the example shown in FIG. 6, the column of the matrix of the table is age. By using the data storing unit 100 shown in FIG. 6, the fitness tool 10 can select and output the character string or image in accordance with the sex and the age that is another example of the user information.

Returning to FIG. 3, the identifying information storing unit 10 stores tool identifying information that individually identifies the fitness tool 10.

The user information storing unit 120 stores information indicating a status of the use of the fitness tool 10 by the user 3.

FIG. 7 shows an exemplary data structure of the user information storing unit 120. In the shown example, the user information storing unit 120 has fields of user ID, sex, age, accumulated exercise amount and accumulated time. Therefore, according to the shown example, the user information storing unit 120 can store the sex, the age, the accumulated exercise amount and the accumulated exercise time for each of a plurality of users. Please note that the user ID field may store the user name in place of the user ID.

Returning to FIG. 3, the input unit 130 includes a power switch of the fitness tool 10. When the fitness tool 3 has been turned on, the input unit 130 sends this fact to the accumulated time measuring unit 140 and the accumulating unit 160. The input unit 130 also acquires the user ID from the user 3 and outputs the acquired user ID to the accumulated time measuring unit 140 and the accumulating unit 160.

The accumulated time measuring unit 140 measures a time from the time at which the fitness tool 10 was turned on until the fitness tool 10 is turned off, when receiving the notification from the input unit 130. Also, when receiving the user ID from the input unit 130, the accumulated time measuring unit 140 obtains the accumulated time stored to correspond to the received user ID from the user information storing unit 120. The accumulated time measuring unit 140 then adds newly measured time to the accumulated time obtained from the user information storing unit 120 so as to update the accumulated time. In other words, the accumulated time measuring unit 140 measures the time during which the fitness tool 10 was used, that is, the accumulated exercise time, for each user. The accumulated time measuring unit 140 outputs the accumulated time after being updated to the output unit 170, when receiving a request from the output unit 170. When receiving a notification that the fitness tool 10 was turned off from the input unit 130, the accumulated time measuring unit 140 outputs the accumulated time after being updated to the user information storing unit 120, thereby updating the data stored in the user information storing unit 120.

The exercise amount measuring unit 150 detects the use of the fitness tool 10, that is, the exercise of the user, and then measures the exercise amount so as to output the measured exercise amount to the accumulating unit 160. In a case where the fitness tool 10 is a tool that generates vibration by repetitive exercise by the user, such as a pedometer, a stepper, a dumbbell, a rope for jumping rope, or a popping, the exercise amount measuring unit 150 counts the number of vibration times of the fitness tool 10 as the exercise amount. Moreover, in a case where the fitness tool 10 is a tool that makes the user take repetitive twisting exercise, such as a twister, the exercise amount measuring unit 150 counts the number of the times of repetitive driving of a part of the tool that is repeatedly driven by the twisting, as the exercise amount. Furthermore, in a case where the fitness tool 10 is a device that forces the user to take continuous exercise, such as an exercise bike or a walker, the exercise amount measuring unit 150 measures the continuous exercise amount, for example, the number of rotations of the driving part of the device, as the exercise amount.

When acquiring the user ID from the input unit 130, the accumulating unit 160 acquires the accumulated exercise amount stored to correspond to the acquired user ID from the user information storing unit 120. Then, when receiving the exercise amount from the exercise amount measuring unit 150, the accumulating unit 160 adds the received exercise amount to the accumulated exercise amount thus acquired, thereby updating the accumulated exercise amount. The accumulating unit 160 then outputs the accumulated exercise amount after being updated to the output unit 170. Moreover, the accumulating unit 160 outputs the accumulated time after being updated to the user information storing unit 120 when receiving the notification that the fitness tool was turned off from the input unit 130, thereby updating the accumulated time in the user information storing unit 120.

In a case where the accumulated exercise amount received from the accumulating unit 160 reaches the exercise amount forming the column or row of the matrix data in the data storing unit 100, the output unit 170 outputs to the processing unit 180 a request for outputting the exercise amount, the accumulated time at that time, and the character string or image corresponding to the user information. When receiving the character string or image from the processing unit 180, the output unit 170 outputs the received character string or image on the display 190.

The output unit 170 may output the received character string or image together with necessary information directly to the point-giving server 40 via the communication network. Moreover, the output unit 170 may output the received character string or image to an external display device so that the character string or image is displayed on the external display device.

When receiving the request for outputting the character string or image from the output unit 170, the processing unit 180 reads out the corresponding character string or image from the data storing unit 100. The processing unit 180 also reads out the tool identifying information stored in the identifying information storing unit 110 and processes the character string or image in accordance with a predetermined rule by using the tool identifying information as a key. This process includes encryption.

The display 190 displays the character string or image received from the output unit 170, in order to make the user recognize the character string or image.

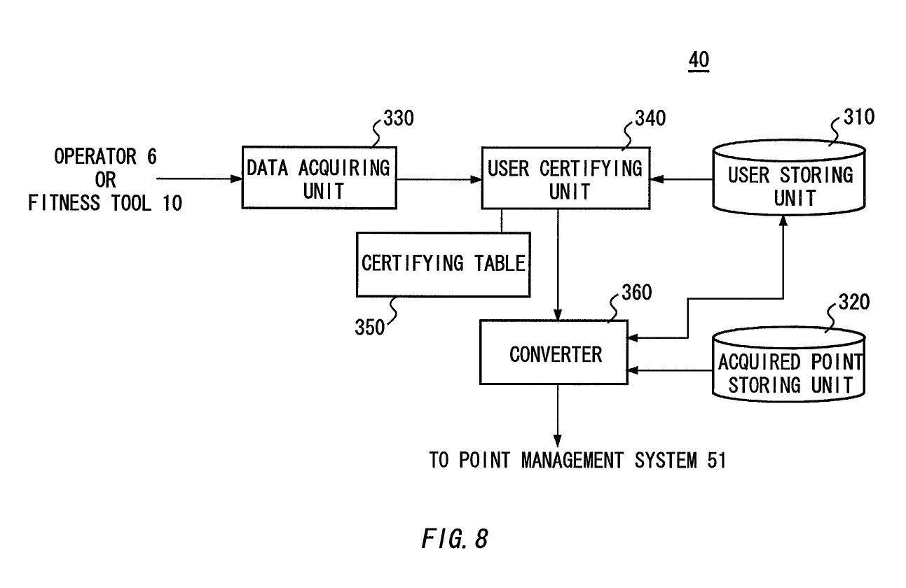

FIG. 8 shows an exemplary structure of the point-giving server 40. In the shown example, the point-giving server 40 includes a data storing part and a functional part. The data storing part is formed by a user storing unit 310 and an acquired point storing unit 320, while the functional part is formed by a data acquiring unit 330, a user certifying unit 340 and a converter 360. The user certifying unit 340 has a certifying table 350.

The user storing unit 310 stores various types of information of the user who used the point-giving server 40.

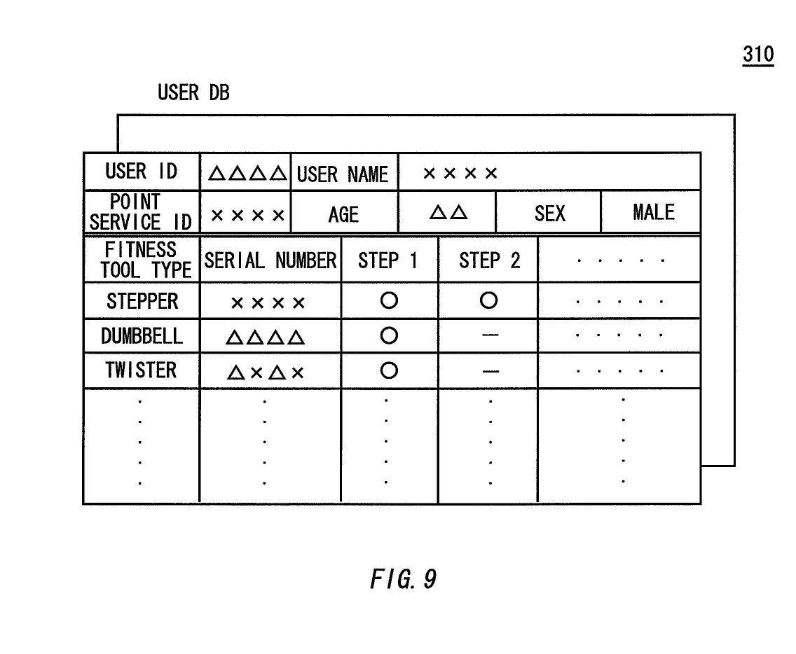

FIG. 9 shows an exemplary data structure of the user storing unit 310. In the shown example, the user storing unit 310 has fields of user ID, user name, point service ID, age, sex and point history. The age, sex and the like stored in the user storing unit 310 are kept reliable by being checked with the data of the point management system 51.

The user ID field stores the user ID of the point-giving server 40, that was assigned to the user. The point service ID field stores the ID given to the user by the point management company 5.

The point history field further has fields of fitness tool type, serial number and step. The fitness tool type field and the serial number field store the name and the serial number of the fitness tool used by the user. The step field stores, in a case where the exercise amounts for which points are to be given are classified into a plurality of steps for each fitness tool, data indicating whether or not the points in the respective step has been already given.

Returning to FIG. 8, the acquired point storing unit 320 stores data specifying the points to be given to the user.

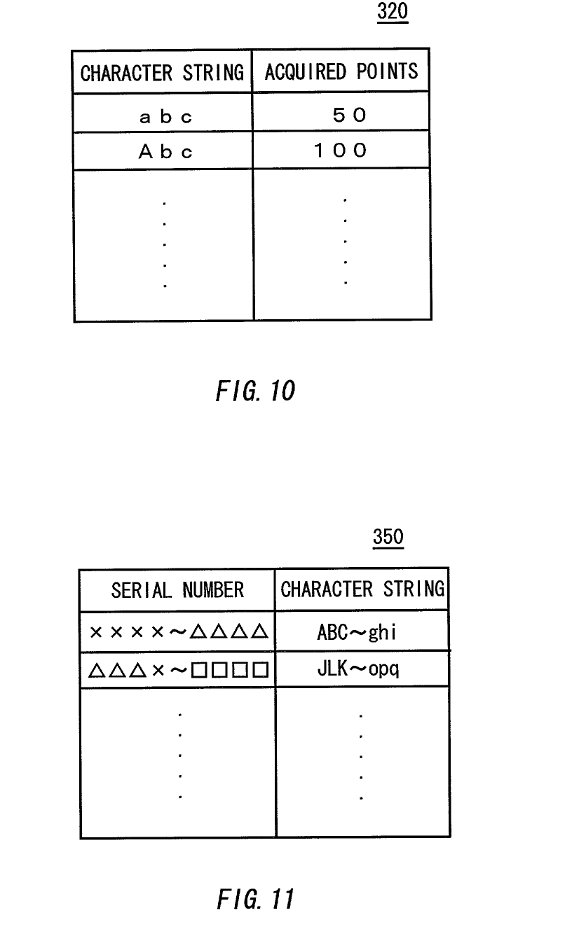

FIG. 10 shows an exemplary data structure of the acquired point storing unit 320. In the example shown in FIG. 10, the acquired point storing unit 320 has a table in which character strings or images correspond to acquired points.

Returning to FIG. 8, the data acquiring unit 330 acquires the character string or image, and necessary information from the operator 6 and outputs the acquired information to the user certifying unit 340. The data acquiring unit 330 may acquire the character string or image and the necessary information from the fitness tool 10 or a terminal of the user via the communication network.

The user certifying unit 340 performs a certifying operation for the giving of the points to the user by using the information received from the data acquiring unit 330 and the certifying table 350. In a case where the point-giving to the user was successfully certified, the user certifying unit 340 outputs the information received from the data acquiring unit 330 to the converter 360.

FIG. 11 shows an exemplary data structure of the certifying table 350. In the example shown in FIG. 11, the certifying table 350 stores serial numbers or product IDs and character strings or images so as to correspond to each other. In other words, in a case where a combination of the received serial number or product ID and the character string or image is coincident with a combination stored in the certifying table 350, the user certifying unit 340 approves the point giving to the user. Please note that the user certifying unit 340 performs an operation for recovering the processed character string or image in accordance with the rule used by the processing unit 180 of the fitness tool 10, if the character string or image was processed. In this manner, the user certifying unit 340 recognizes the serial number or product ID as one character string, so that combinations of a plurality of types of character strings or images can be made to correspond to points.

Returning to FIG. 8, the converter 360 reads out the points corresponding to the character string or image received from the user certifying unit 340, from the acquired point storing unit 320, and recognizes the read points as the points to be given to the user. The converter 360 then reads out the point service ID of the user from the user storing unit 310, and outputs the read point service ID to the point management system 51 in such a manner that the point service ID corresponds to the recognized points.

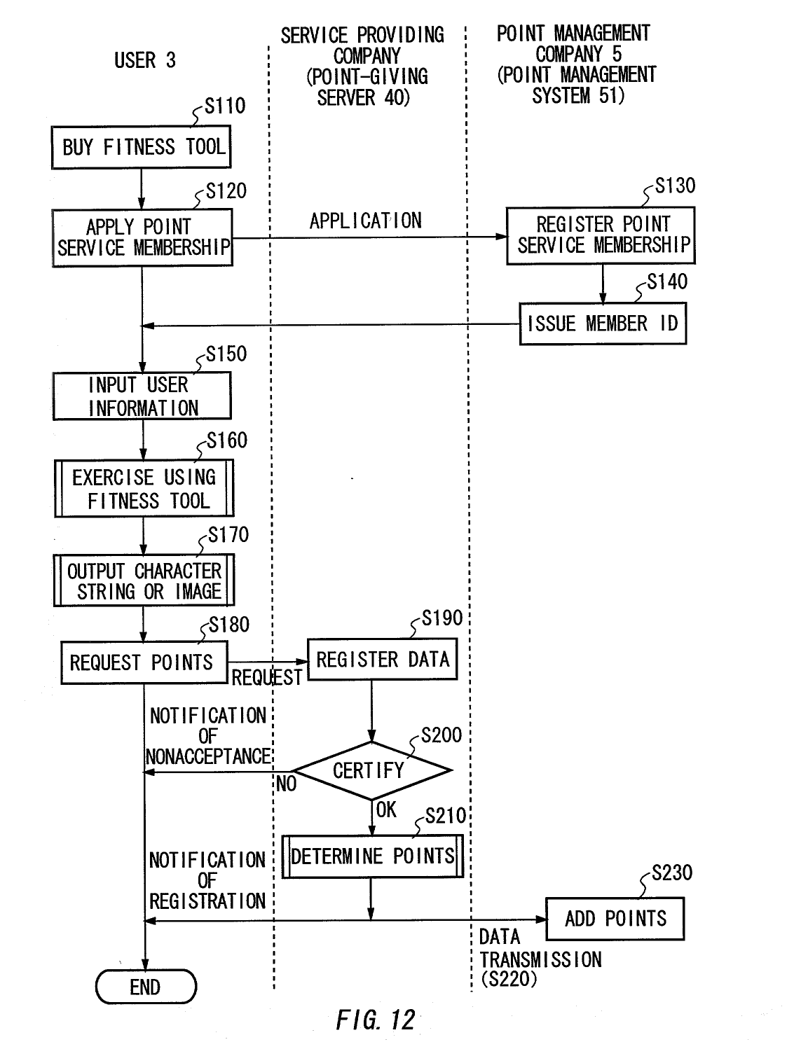

FIG. 12 is a flowchart of an exemplary operation of the entire point-giving system according to the present invention.

In the shown example, the user 3 first buys the fitness tool 10 from the shop 2 (Step S110). The user 3 fills in an application of the point service membership and then sends it to the point management company 5 (Step S120). The point management company 5 registers the membership of the point service based on the contents of the application of the point service membership (Step S130), issues the point service member ID (member card) and then sends it to the user 3 (Step S140). The application of the point service membership is the same as that usually used in the point management company 5. In a case where the user 3 already has membership of the point service of the point management company 5, Steps S110 to S140 can be omitted.

The user 3 then inputs user information to the fitness tool 10 (Step S150). When the user took exercise using the fitness tool 10 (Step S160), the fitness tool 10 outputs a character string or image (Step S170). The user 3 then informs the service providing company 4 of the output character string or image, that is, makes the service providing company 4 input the output character string or image to the point-giving server 40, thereby requesting the point-giving server 40 to give points to the user (Step S180). The user 3 may contact the service providing company 4 by phone, mail, facsimile or e-mail, or through a homepage on the Internet. Moreover, the service providing company 4 may commission the point management company 5 to actually perform reception work. In the case where the point management company 5 performs the reception work, the basic structure is not changed except that the management server 400, including the operator 6 in some cases, are included in the point management company 5.

After the point-giving server 40 records various types of information input thereto (Step S190), the certifying operation is performed by the user certifying unit 340 (Step S200). The converter 360 then determines the point to be given (Step S210) and transmits the determined points to the point management system 51 (StepS220). The point-giving server 40 or the service providing company 4 then sends notification of point registration to the user 3.

When the point management system 51 receives the points from the point-giving server 40, the point management system 51 adds the received points to the accumulated points for the user 3 (Step S230).

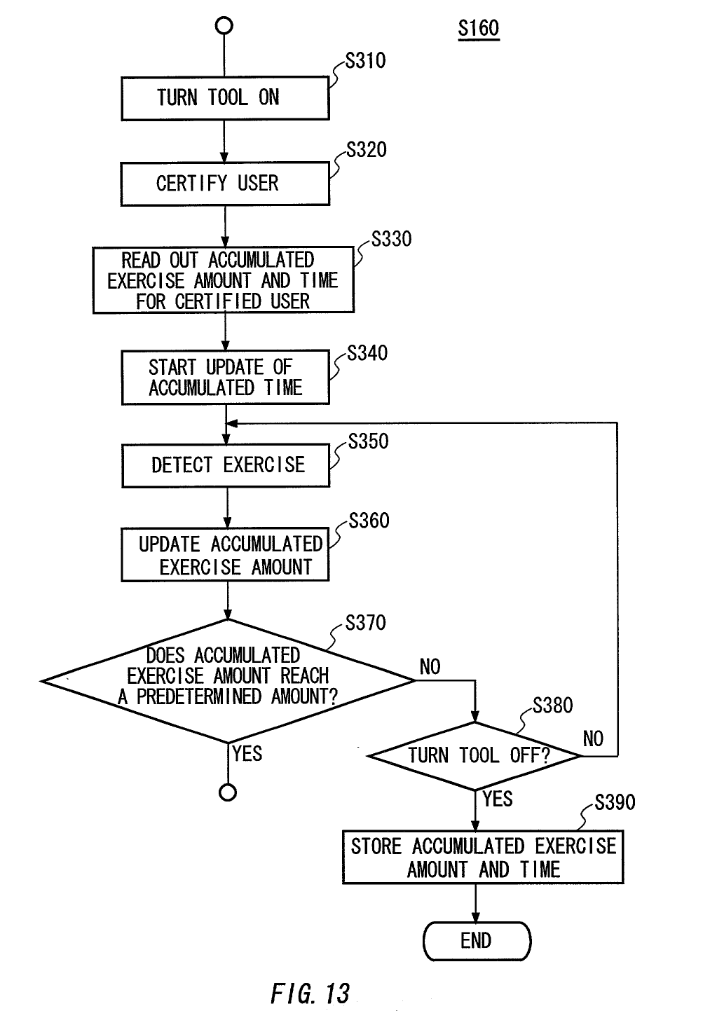

FIG. 13 shows details of Step S160 in the flowchart shown in FIG. 12. When the input unit 130 of the fitness tool 10 detects that the fitness tool 10 was turned on (Step S310), the accumulated time measuring unit 140 and the accumulating unit 160 certifies the user by using the input of the user ID (Step S320), and then reads out the accumulated exercise amount and time for the certified user (Step S330). The accumulated time measuring unit 140 then starts to measure the accumulated time, that is, update the accumulated time (Step S340). When the exercise amount measuring unit 150 detects the exercise by the user (Step S350), the accumulating unit 160 updates the accumulated exercise amount (Step S360).

In a case where the output unit 170 determines that the accumulated exercise amount has reached a predetermined exercise amount, the flow goes to Step S170 in FIG. 12 (Step S370: Yes). In a case where it was determined that the accumulated exercise amount had not reached the predetermined exercise amount (Step S370: No), the flow goes to Step S380. Then, in a case where the input unit 130 has not detected that the fitness tool 10 is turned off (Step S380: No), the flow goes back to Step S350. In another case where the input unit 130 has detected that the fitness tool 10 was turned off (Step S380: Yes), the accumulated time measuring unit 140 and the accumulating unit 160 store the accumulated time and the accumulated exercise amount in the user information storing unit 120, thereby updating the accumulated exercise amount and time (Step S390).

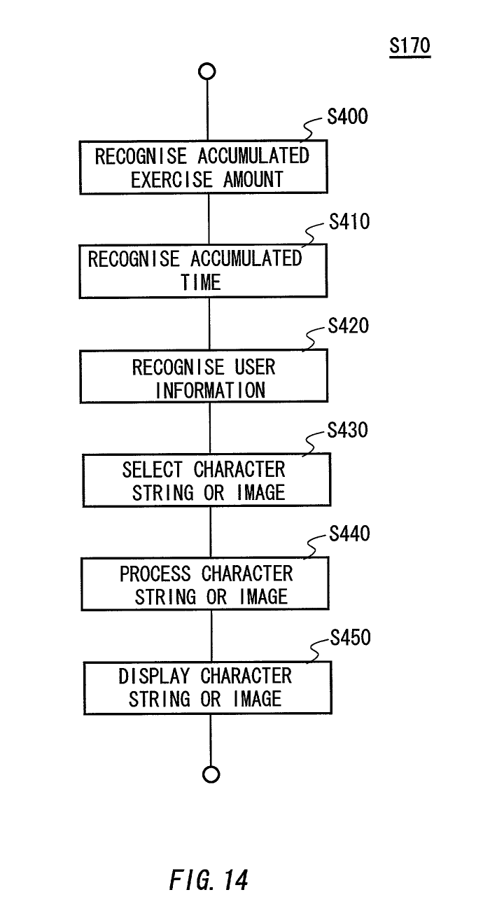

FIG. 14 shows details of Step S170 in the flowchart shown in FIG. 12. The output unit 170 recognizes the accumulated exercise amount (Step S400) and also recognizes the accumulated time (Step 30 S410). The output unit 170 then recognizes the user information, such as sex or age (Step S420). The processing unit 180 selects the character string or image (StepS430), processes it (StepS440), and then transmits the processed character string or image to the display 190 via the output unit 170. The display 190 displays the received character string or image (Step S450).

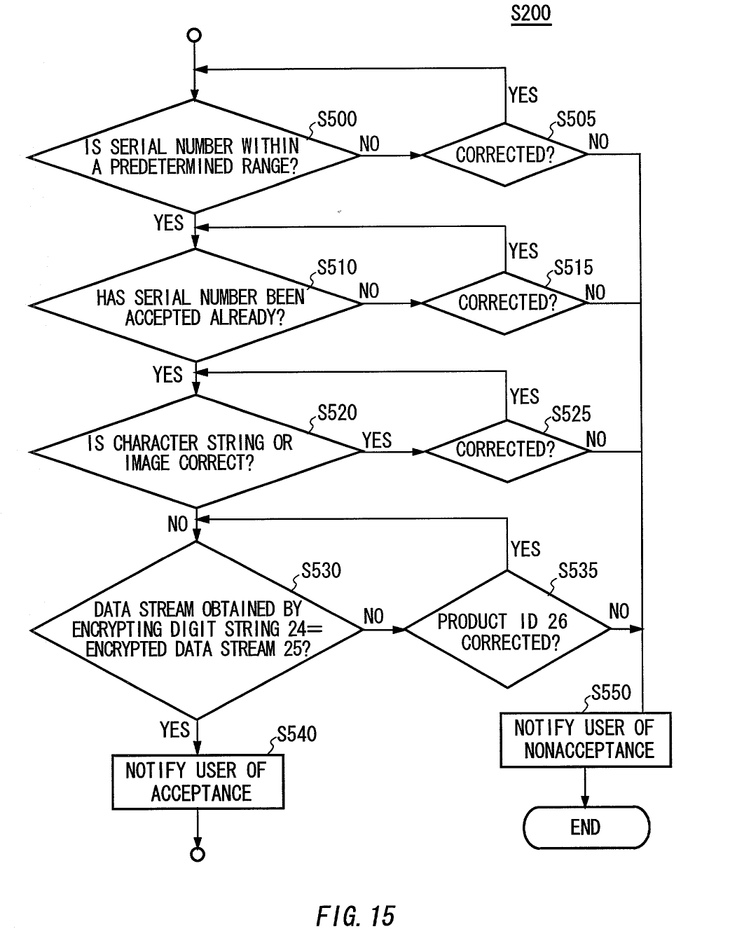

FIG. 15 shows details of Step S200 in the flowchart shown in FIG. 12. The user certifying unit 340 of the point-giving server 40 checks whether or not the serial number is within a range of the numbers used as serial numbers of fitness tools 10, by using the certifying table 350 (Step S500). At this time, the user certifying unit 340 performs a recovering operation for recovering the character string or image in a case where the character string or image was processed. The user certifying unit 340 then refers to the history so as to check whether or not the same serial number has been accepted already (Step S510). Moreover, the user certifying unit 340 checks whether or not the character string or image is correct by using the certifying table 350 (Step S520). If the serial number is incorrect or has been accepted already, or the character string or image is incorrect, the user certifying unit 340 notifies the user of that fact and then waits for the correction by the user 3. In a case where the user 3 did not make correction (Steps S505, 515 and 525), the user certifying unit 340 notifies the user of nonacceptance (Step S550) and finishes the operation.

In a case where there is no problem with the serial number and the character string or image, the product ID is subjected to a certifying operation (Step S530). If the data stream obtained by encrypting the digit string 24 forming the product ID is coincident with the data stream 25 included in the received product ID, the user 3 is successfully certified. However, if they are not coincident with each other, the user certifying unit 340 waits for the correction by the user 3. In a case where no correction was made (Step S535), the user certifying unit 340 notifies the user of nonacceptance and finishes the operation.

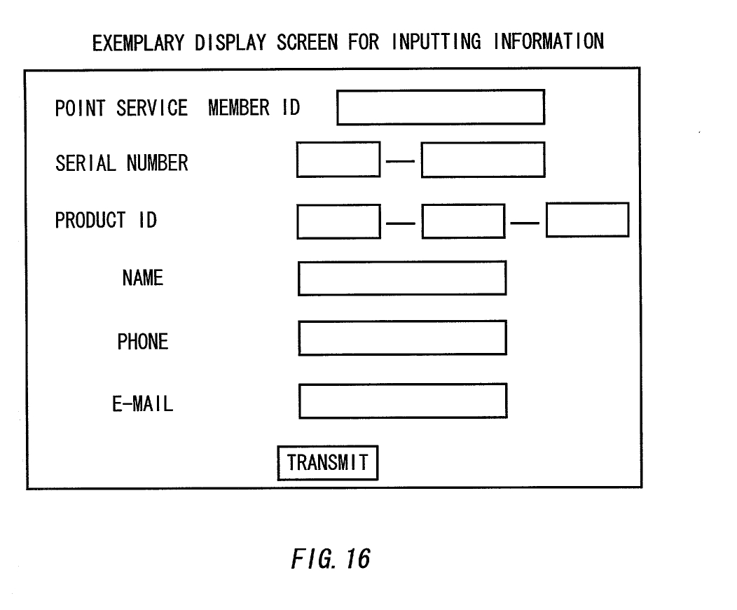

FIG. 16 shows an exemplary display screen of a HP in a case where the character string or image is received through the HP in Step S180 in the flowchart shown in FIG. 12. In the shown example, the display screen for inputting information has fields of point service member ID, serial number, product ID, name, phone and e-mail and a button for data transmission.

As is described above, according to the point-giving system of the present embodiment, the user 3 can acquire points of the point service company by taking exercise using the fitness tool 10 the user bought. In other words, the user can take exercise continuously by using the fitness tool 10 while retaining the object for accumulating the points. Thus, it is possible to build up the user's health.

The service providing company 4 can promote the sales of the fitness tools 10 by using the point-giving system of the present invention.

Moreover, the point management company 5 can increase the members by increasing the users of the present point-giving system. In a case where the point management company 5 is an airline, users of airlines can be expected to increase.

In addition, in the present point-giving system, even if the character string or image is found by a person other than the proper user, it is possible to keep the reliability because the product ID is checked. Moreover, since the serial number is also checked, it is possible to manage the number of the point-giving requests based on the number of products actually shipped. Therefore, it becomes difficult that the service providing company or the user is damaged by an ill-intentioned person.

Furthermore, in a case where the production number or serial number is encrypted to generate a character string, the certifying operation can be performed only by that character string and the production number or serial number. Therefore, the reliability can be improved without using the product ID.

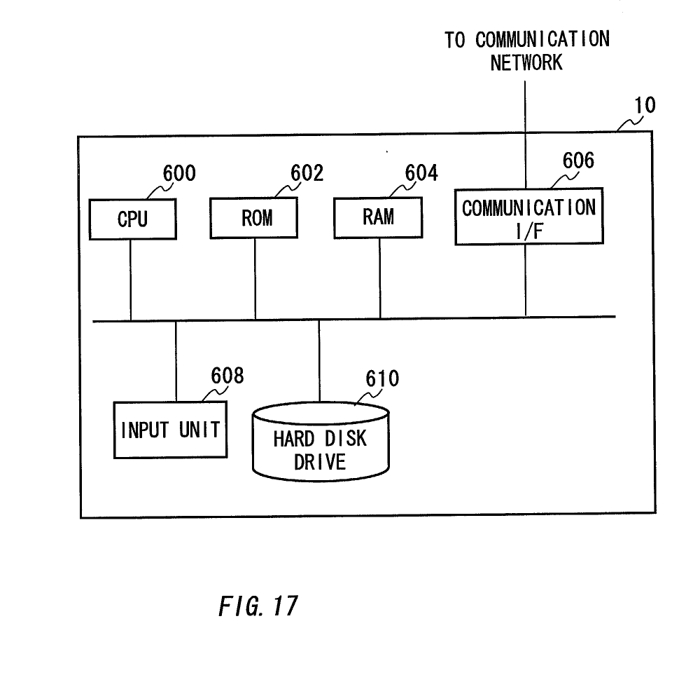

FIG. 17 illustrates an exemplary hardware configuration of the fitness tool 10. The fitness tool 10 includes a CPU 600, a ROM 602, a RAM 604 and a communication interface 606. The CPU 600 operates based on at least one program stored in the ROM 602 and RAM 604. The communication interface 606 communicates with the point-giving server 40 through the communication network. An input unit 608 obtains necessary information such as the user information or the serial number, being input by the user, for example, via an input button or the like. A hard disk drive 610 as an exemplary storage device stores setting information and the information obtained during the operation.

The software executed by the CPU 600 may be provided to the user while being stored in a recording medium such as a floppy disk (registered trademark) or a CD-ROM. The software stored in the recording medium may be compressed or not-compressed. In this case, the software is installed into the hard disk drive 610 from the recording medium and is then read into the RAM 604, so that the CPU 600 executes the software.

As the recording medium in this case, other than the floppy disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the fitness tool 10 through the communication network. Such a recording medium is used only for manufacturing the fitness tool 10 and it is therefore apparent that the manufacturing, sales and the like of such a recording medium on business constitutes infringement of a right based on the present application.

The aforementioned software functionally includes an input module, a time measuring module, an exercise amount measuring module, an accumulating module, an output module and a processing module. Operations that are to be executed by the CPU 600 in accordance with instructions of the respective modules are the same as the functions and operations of the corresponding components in the fitness tool 10 of the present embodiment, respectively, and therefore the description thereof is omitted.

The above-mentioned programs may be stored in a single recording medium such as the ROM 602 or a plurality of recording media. Moreover, the modules stored in the recording medium may provide the respective functions by cooperating with an operating system. For example, the module may instruct the operating system to perform a part or all of the functions and provide the respective functions in accordance with a response from the operating system.

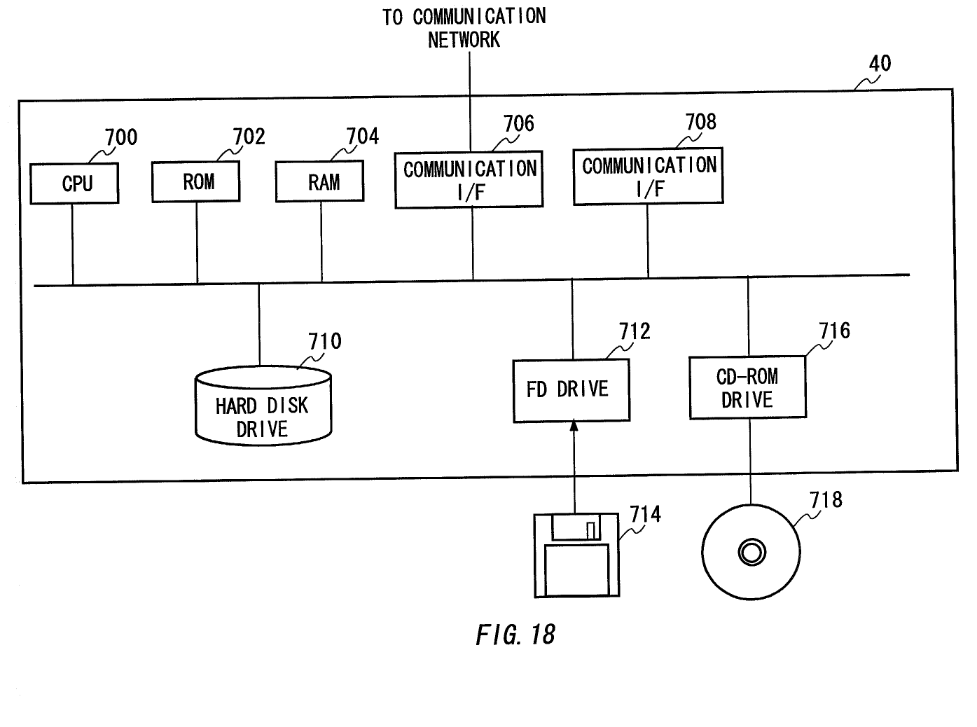

FIG. 18 illustrates an exemplary hardware configuration of the point-giving server 40. The point-giving server 40 includes a CPU 700, a ROM 702, a RAM 704 and communication interfaces 706 and 708. The CPU 700 operates based on at least one program stored in the ROM 702 and RAM 704. The communication interface 706 communicates with a terminal of the user or the fitness tool 10 through the communication network. The communication interface 708 communicates with the point management system 51 via an exclusive line. A hard disk drive 710 as a storage device stores setting information and the program in accordance with which the CPU 700 operates.

A floppy disk drive 712 reads data or a program from a floppy disk 714 and provides the read data or program to the CPU 700. A CD-ROM drive 716 reads data or a program from a CD-ROM 718 and provides the read data or program to the CPU 700. The communication interface 706 transmits/receives the data by connecting the communication network 10.

The software executed by the CPU 700 may be provided to the user while being stored in a recording medium such as the floppy disk (registered trademark) 714 or the CD-ROM 718. The software stored in the recording medium may be compressed or not-compressed. The software is installed into the hard disk drive 710 from the recording medium and is then read into the RAM 704, so that the CPU 700 executes the software.

The aforementioned software stored in the recording medium, that is the software to be installed into the hard disk drive 710, functionally includes a data acquiring module, a user certifying module and a converting module. Operations that are to be executed by the CPU 700 in accordance with instructions of the respective modules are the same as the functions and operations of the corresponding components in the point-giving server 40 of the present embodiment, respectively, and therefore the description thereof is omitted.

The floppy disk 714 or CD-ROM 718 as an example of the recording medium, shown in FIG. 18, can store a part or all of the functions of the point-giving server 40 in all the embodiments described in the present application.

The above-mentioned programs may be executed after being read directly into the RAM from the recording medium, or may be executed after being installed into the hard disk drive and is then read out to the RAM. Moreover, the programs may be stored in a single recording medium or a plurality of recording media. In addition, the modules stored in the recording medium may provide the respective functions by cooperating with an operating system. For example, the module may instruct the operating system to perform a part or all of the functions and provide the respective functions in accordance with a response from the operating system.

As the recording medium in this case, other than the floppy disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the point-giving server 40 through the communication network. Such a recording medium is used only for manufacturing the point-giving server 40 and it is therefore apparent that the manufacturing, sales and the like of such a recording medium on business constitutes infringement of a right based on the present application.

(Embodiment 2)

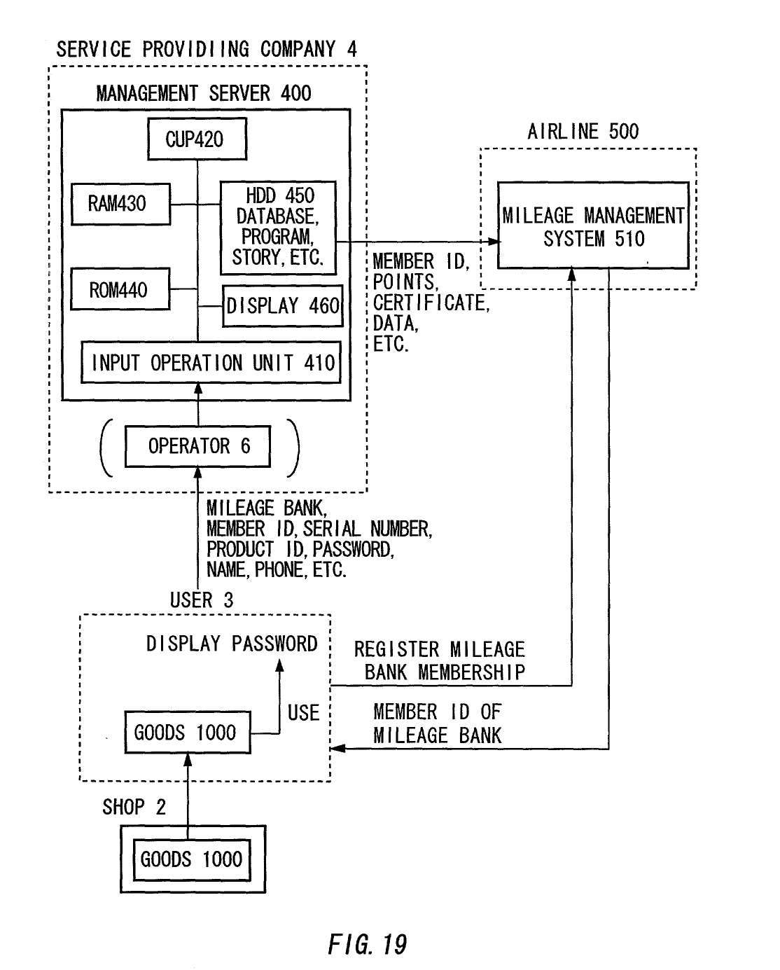

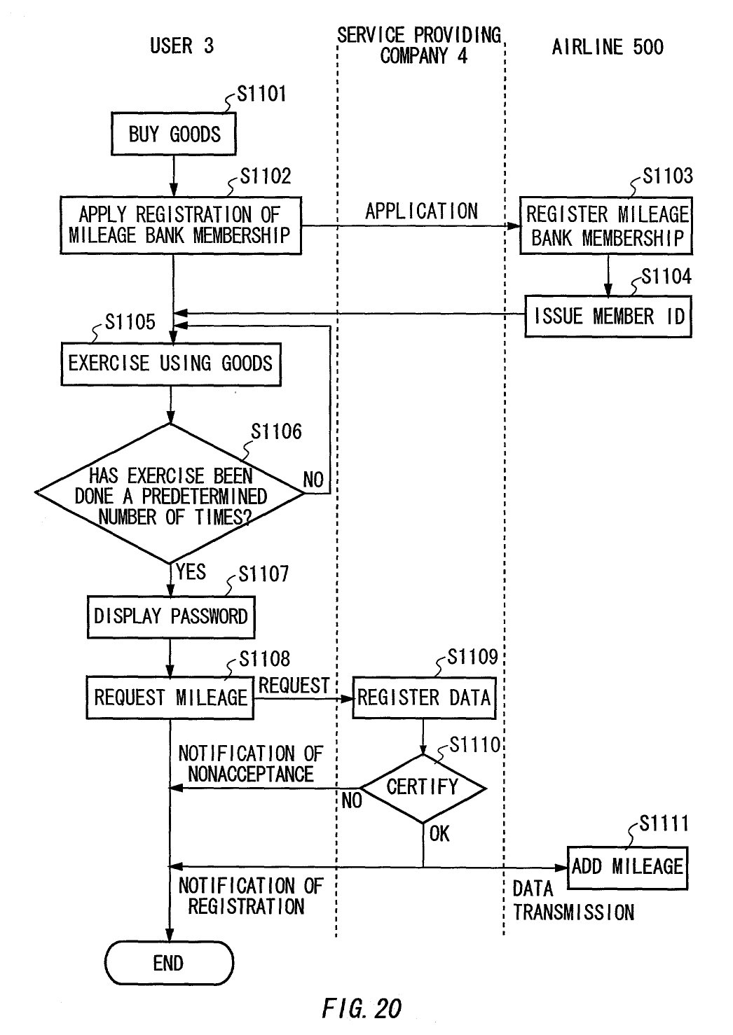

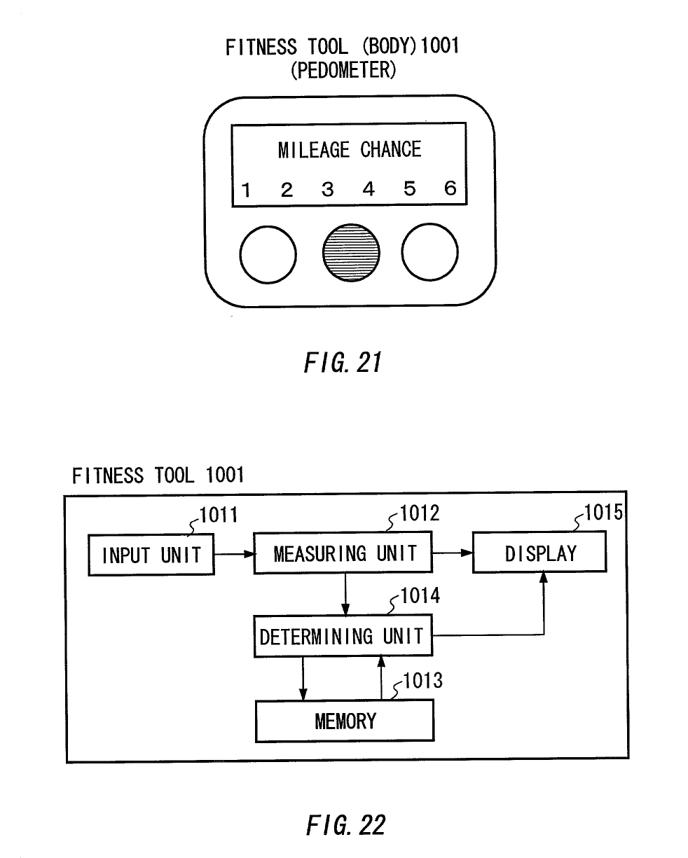

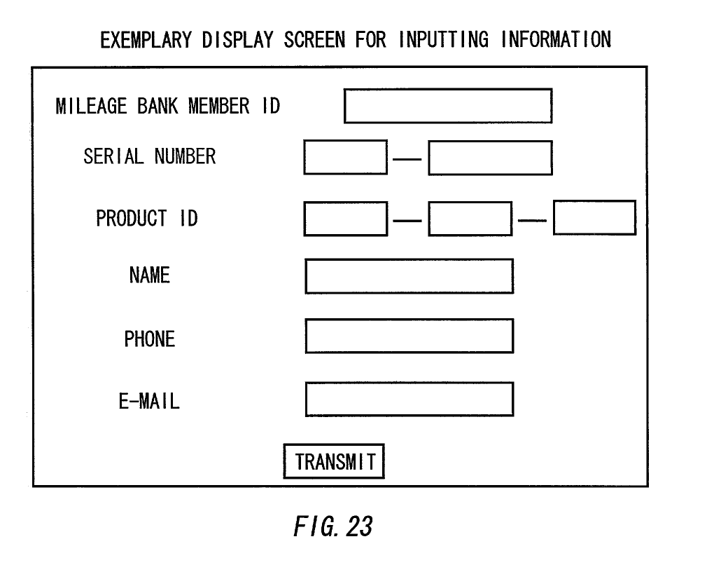

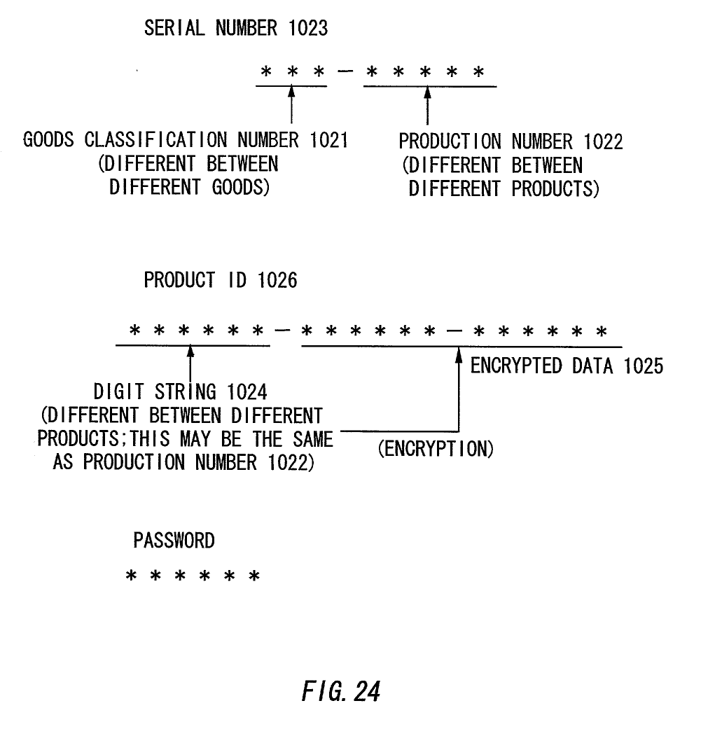

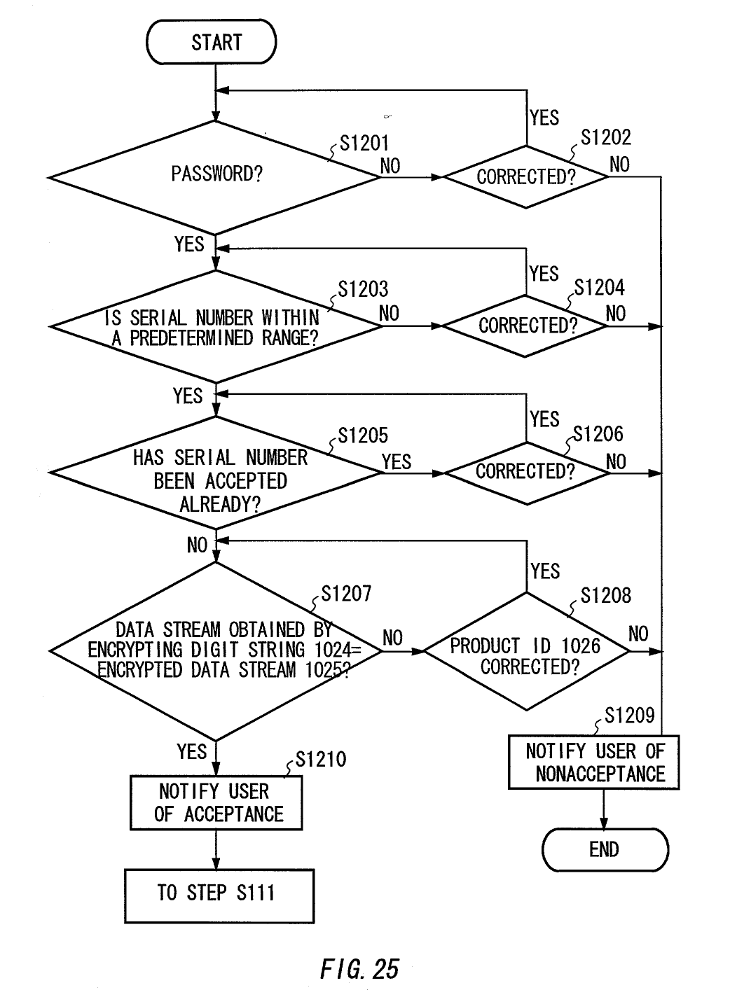

Next, a point system and a fitness tool according to the second embodiment of the present invention are described in detail, referring to the drawings. FIG. 19 shows a structure of this point system; FIG. 20 is a flowchart of a procedure of the point system of the second embodiment; FIG. 21 is a general appearance of the fitness tool of the second embodiment; FIG. 22 is a block diagram of the internal structure of the fitness tool of the second embodiment; FIG. 23 schematically shows an exemplary display screen for allowing a user to submit an application of the point service membership; FIG. 24 shows an example of a serial number, a product ID and a password; and FIG. 25 is a flowchart of a certifying procedure in a management server.

First, the fitness tool of the second embodiment is described, referring to FIGS. 21 and 22.

The fitness tool used in the present invention is an exercise tool used mainly at home, and includes a fitness tool such as a stepper, a dumbbell, a twister, a rope for jumping rope, a popping, an exercise bike and a walker, a measurement tool for measuring the number of the times of exercise, such as a pedometer, and a party game requiring the player's movement.

When the user took exercise using the fitness tool 1001, as shown in FIG. 22, the number of times the user takes exercise is input to an input unit 1011. The number of exercise times input to the input unit 1011 is counted by a measuring unit 1012 so as to be displayed on a display 1015. Thus, the user can find how many times the user took exercise.

Moreover, the fitness tool 1011 includes a memory 1013 for storing a predetermined number of the input times and a predetermined password, and a determining unit 1014 to which the number of exercise times measured by the measuring unit 1012 and the predetermined number of the input times stored in the memory 1013 are input. The number of exercise times and that of the input times are then compared with each other. The determining unit 1014 reads out the password stored in the memory 1013 when the number of exercise times has reached the predetermined number, and displays the read password on the display 1015.

FIG. 21 shows an exemplary screen where the password is displayed in a case of using a pedometer as the fitness tool 1001. In the shown example, an indication “Mileage chance” is displayed together with 6-digit password “123456”. This shows the user that this password can be used for accumulating the mileage points.

According to the above structure, when the user has taken exercise using the fitness tool a predetermined number times (10000 times, for example), the password is displayed on the display 1015. This password certifies that the user took exercise the predetermined number times.

Please note that the password to be displayed may be the same for the same type product. However, the password may be generated based on a number unique to the product, such as a production number. In this case, the memory 1013 may store the password generated based on the number unique to that product, or store the number unique to the product, that is used for generation of the password, together with an encrypting program. In the latter case, the password can be generated in accordance with the encrypting program.

Moreover, the memory 1013 may store a plurality of numbers as the predetermined exercise times and a plurality of passwords corresponding to the respective numbers so as to allow one of the passwords selected in accordance with the number of the exercise times input from the input unit loll to be displayed. It should be noted that the passwords may be generated. For example, in the case of the pedometer shown in FIG. 21, different passwords may be displayed every 100,000 steps and, when the number of the user's steps has reached the number of the steps required for walking around the earth, a special password may be displayed. In addition, in the point system described later, different points (more points for more steps) may be given depending on the passwords.

Furthermore, in a case where the fitness tool 1001 is a tool used while being connected to a TV monitor (not shown), it is not necessary to provide the display 1015. Instead of the display 1015, the TV monitor may display the number of exercise times and the password output from the fitness tool 1001.

Next, the point system of the present invention is described mainly referring to FIGS. 19 and 20. The following description is made referring to a system for accumulating and storing points of the mileage system provided by an airline. However, even in a case where the user accumulates and stores points provided by a credit card company, the system can be realized similarly only by changing the words “airline” and “mileage” to “credit card company” and “card points” in FIGS. 19 and 20 and the description relevant to FIGS. 19 and 20.

First, the user 3 buys the goods 1000 from a shop 2 (Step S1101). The user3 may buy the goods 1000 by mail order or on-line shopping. In the goods 1000, a fitness tool (body 1) to which a serial number 1023 composed of a goods classification number 1021 and a production number 1022 is assigned, an operating manual 1031, an application sheet of mileage bank membership 1032 and a certificate 103 are packed. In the certificate 1033, a product ID 1026 composed of a digit string (or an alphanumeric character string or a string of alphanumeric characters and symbols) 1024, different between different products, and en encrypted data stream 1025 obtained by encrypting this digit string 1024 is written together with the serial number 1023. The product ID 1026 or the digit string 1024 or the encrypted data stream 1025 may be covered by a seal or silver coating so as not to be seen until the user peels off the seal or the silver coating. In addition, the digit string 1024 may be the same as the production number 1022 (see FIG. 24).

The user 3 fills in the application of the mileage bank membership 1032 and then sends the application to the airline 500 (Step S1102). The airline 500 registers the membership based on the contents of the application (Step S1103), issues a mileage bank member ID (mileage bank member card) and sends it to the user 3 (Step S1104). Please note that the mileage bank membership application 1032 is the same as that usually used in the airline 500. If the user 3 has already got the membership of the mileage bank of the airline 500, this application procedure (Steps S1102 to S1104) is not necessary.

When the user took exercise using the fitness tool 1001 (Step S1105) and the number of the exercise times has reached a predetermined number (Step S1106: Yes), the user 3 can acquire the password.

The user 3 requests the addition of the mileage by informing the service providing company 4 of the acquired password (Step S1108). The user 3 can contact the service providing company 4 by phone, mail, facsimile, or e-mail, or through a HP of the service providing company 4. Moreover, the service providing company 4 may commission the airline 500 to actually perform reception work. In a case where the airline 500 performs the reception work, the basic structure is not changed except that the management server 400 described later and the operator 6 are included in the airline 500. In the following description, it is assumed that the service providing company 4 does the reception work.

The user 3 calls a reception phone number of the service providing company 4 and tells an automated reception system or the operator 6 the following information.

(1) Member ID of the mileage bank (already obtained from the airline 500)

(2) Serial number 1023 (written on the fitness tool 1001 and in the certificate 1033)

(3) Product ID 1026 (written in the certificate 1033)

(4) Password (displayed when the exercise has been done a predetermined number of times)

(5) Name, phone number and the like (to be used when it is necessary to contact the user 3)

The operator 6 operates an input operation unit 410 such as a keyboard or a voice-input device of the management server 400 in the service providing company 4 SO as to input the information (1) to (6). Also in a case where the information was received via mail, facsimile or the like, the items (1) to (6) are input by operating the input operation unit 410. In a case of receiving by e-mail or via the HP, the management server 400 may be construed so as to allow the automatic input. In the latter case, a system for receiving the e-mail or a HP server corresponds to the input operation unit 410. FIG. 23 shows an exemplary display screen for receiving information via the HP.

The management server 400 includes the input operation unit 410, a CPU 420 for executing the various procedures, a RAM 430 for temporarily storing data required for the procedures, a ROM 440 in which a program is required for the basic operation of the management server 400, a hard disk drive (HDD) 450 in which all programs and a database required for the reception work and a reception history are stored, and a display 460 for notifying the operator 6 of the contents of the input by the input operation unit 410, the result of the reception procedure, and the like.

The management server 400 stores the various types of data input thereto in the HDD 450 (Step S1109) and thereafter perform a certifying procedure (Step S1110). An exemplary certifying procedure in the management server 400 is described referring to FIG. 25. First, referring to the database in the HDD 450, it is checked whether or not the password is correct (Step S1201) and whether or not the serial number 1023 is within a range of serial numbers used for this type of fitness tool 10 (Step S1203). Next, it is checked by referring to the history whether or not the same serial number was accepted before (Step S1205). If the password is incorrect, or the serial number is incorrect or was accepted before, the management server 4 notifies the user 3 of this fact. Then, in a case where no correction was made by the user 3 (Steps S1202, S1204 and S1206: No), the management server 4 notifies the user 3 that the request cannot be accepted, thereby finishing the procedure (Step S1209).

In a case where there is no problem with the password or the serial number, the product ID 1026 is subjected to a certifying procedure (Step S1207). As described before, since the product ID 1026 is formed by the digit string (or alphanumeric character string) 1024 different between the different products and the encrypted data stream 1025 obtained by encrypting the digit string 1024, when a data stream, obtained by encrypting the digit string 1024 included in the received product ID 1026 in accordance with the encryption program stored in the HDD 450, is coincident with the encrypted data stream 1025 included in the received product ID 1026, it can be determined that the user 3 is the proper user who bought the goods 1000. If they are not coincident with each other, it is checked whether or not the user 3 told the number to the operator 6 incorrectly (Step S1208). The management server 400 then notifies the user 3 that the request cannot be accepted, thereby finishing the procedure (Step S1209).

In a case where the data stream obtained by encrypting the digit string 1024 in the product ID 1026 is coincident with the encrypted data stream 1025, the management server 400 notifies the user that the addition of the mileage points was accepted, thereby finishing the procedure (StepS1210). In the shown example, the digit string 1024 is encrypted in the management server 400 in accordance with the program to generate the encrypted data stream and then the generated data stream is checked (subjected to the certifying procedure). However, the encrypted data stream may be stored in the database of the HDD 450 so as to correspond to the digit string 1024 and check the encrypted data stream stored in the database of the HDD 450 with the received encrypted data stream 1025.

Moreover, the member ID of the mileage bank was not performed in the shown example. However, if the airline 500 receives the request of the addition of points or if a customer database of the mileage management system 510 of the airline 500 can be referred to, the member ID of the mileage bank received from the user 3 may be checked.

In a case where the service providing company 4 receives the request of the addition of points, it is sometimes difficult to refer to the customer database of the mileage management system 510 of the airline 500. Moreover, even in a case where necessary data of the database of the mileage management system 510 can be provided to the service providing company 4, a precise real-time check is difficult since it takes much time to update the necessary data. However, by checking the product ID 1026, it can be confirmed whether or not the user who requests the addition of points is the proper user of the goods 1000. Therefore, even if the member ID of the mileage bank is not performed, there is no problem. In a case where the member ID of the mileage bank is improper or incorrect, the only problem is that the mileage is not accumulated. This problem can be solved by contacting the user 3 later, for example, by calling the phone number input by the user 3 at the reception, so as to get the correct mileage bank member ID or to notify the user that the mileage was not accumulated.

After the reception was performed normally, the number of the points to be added corresponding to the member ID of the mileage bank and the password is transmitted to the airline 500, thereby causing the accumulated mileage points managed by the mileage management system 510 of the airline 500 to increase (Step S1111). The transmission may be performed real time by on-line processing or batch processing. Moreover, the data may be transmitted to the airline 500 while being stored in a recording medium such as FD, CD-R or MO. In addition, since the data to be transmitted relates to the money transferred between the companies, it is necessary to take care of security of the data transmission. Therefore, the data should be transmitted after being subjected to an appropriate process (encryption or transmission with the manual data, for example), depending on the type of the data.

In this way, the operation of the point system has finished. Please note that a notifying operation for notifying the user 3 of the newly acquired mileage points or total mileage points can be performed together with the general operation of the mileage management system 510.

In a case where the cost corresponding to the increased mileage points is charged to the service providing company 4, the airline 500 charges the service providing company 4 for the cost corresponding to the mileage points received from the service providing company 4 or the service providing company 4 automatically pays for the cost. In both cases, both the service providing company 4 and the airline 500 have the data related to the mileage points. Therefore, by checking both data, the procedure related to charging the cost can be handled without doubt. The service providing company 4 can raise the cost corresponding to the mileage points from profits obtained by selling the goods 1000.

As is described above, according to the point system of the present embodiment, the user 3 can accumulate and store the mileage points of the airline or card points of the credit card company only by taking exercise using the fitness tool 1001 the user 3 bought, with no additional cost.

Moreover, the use of the fitness tool 1001 in order to accumulate the points causes the user 3 to take exercise continuously with a clear object, so that the user's health can be expected to improve.

The service providing company 4 can advertise the goods 1000 by using the point system of the present invention, thereby expecting the increase of sales.

Moreover, the airline 500 can expect the increase of the mileage bank members and the increase of users who use flights of the airline 500 by packing the application of the mileage bank membership in the goods 1000 and increasing the opportunities to accumulate the mileage so as to include the use of the fitness tool, thus contributing to the increase of profits.

In the system of the present invention, even if a person other than the proper user who bought the goods got the password by any means, the person cannot acquire the mileage because the product ID is checked when the request of the addition of mileage is received. Moreover, by checking the serial number as well as the product ID, it is impossible that the users, the number of that exceeds the number of the products actually shipped, acquire the mileage. Therefore, the service providing company or the user can be prevented from being damaged by an ill-intentioned person.

In a case where the password is obtained by encrypting the production number (or the serial number), the certifying procedure can be performed only by using the password and the production number. Therefore, the certifying procedure for checking the proper user can be performed without the product ID, thus preventing the service providing company or the user from being damaged by the ill-intentioned person.

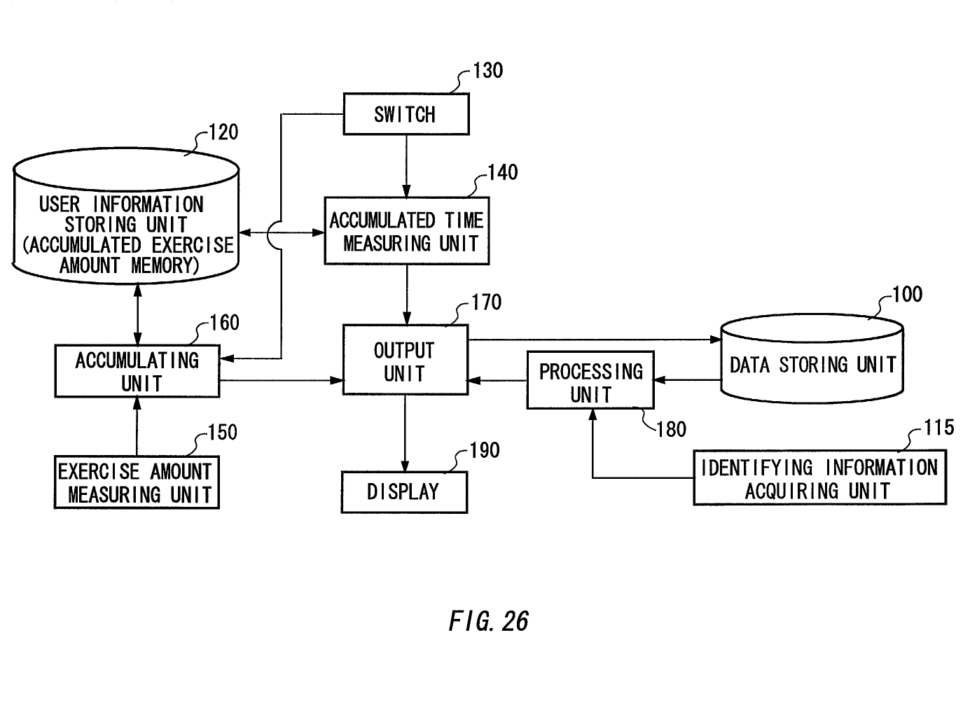

For example, as shown in FIG. 26, an identifying information acquiring unit 115 may be provided in the fitness tool 10 of the first embodiment, in place of the identifying information storing unit 110. The identifying information acquiring unit 115 acquires the tool identifying information from the user, for example, via an external input device.

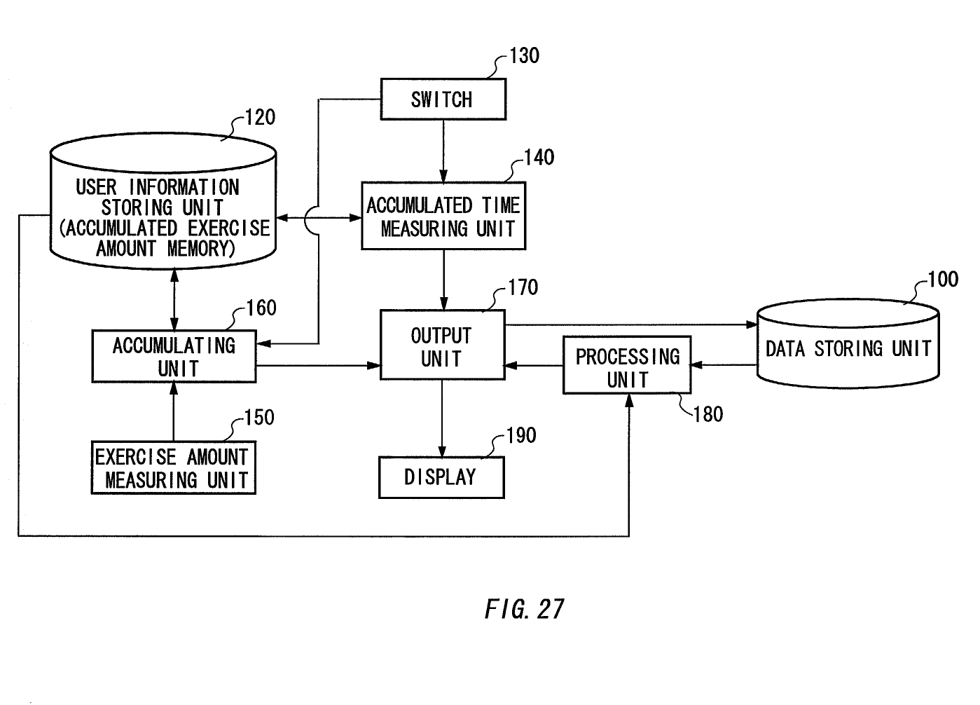

Moreover, as shown in FIG. 27, the identifying information storing unit 110 may be omitted in the first embodiment. In this case, the processing unit 180 obtains the user information such as sex, age, or user ID, and processes the character string or image by using the obtained user information.

The accumulated time measuring unit 140 of the fitness tool 10 may measure the time while the input from the accumulated exercise amount measuring unit 150 is considered as a trigger. In this case, the accumulated time measuring unit 140 considers a time at which the accumulated exercise amount measuring unit 150 first detected the exercise as the first time at which the fitness tool 10 was used.

The point-giving server 40 of the first embodiment may give points in accordance with the serial number. In this case, the character string of the present invention is the serial number. Moreover, in the data structure of the acquired point database 320, the serial numbers and acquired points are stored to correspond to each other.

The character string or image acquired by the data acquiring unit 330 of the point-giving server 40 of the first embodiment may be a character string or image other than the character string or image actually output from the output unit 170, and may be a word indicating an animal or an object shown with the image, for example. In this case, the acquired point storing unit 320 has the data structure in which the words correspond to the points, respectively.

As is apparent from the above, according to the present invention, a fitness tool, a point-giving server, a point-giving system, a point-giving method and a program that can promote the continuous use of the fitness tool can be provided.

Although the present invention has been described by way of exemplary embodiments, it should be understood that those skilled in the art might make many changes and substitutions without departing from the spirit and the scope of the present invention which is defined only by the appended claims.

What is claimed is:

1. A tool for allowing a user to take exercise, comprising:
an exercise amount measuring unit operable to measure an exercise amount of said user;
a data storing unit operable to store a predetermined character string or image; and
an output unit operable to output said predetermined character string or image stored in said data storing unit when said exercise amount measured by said exercise amount measuring unit has reached a predetermined exercise amount.

2. A tool as claimed in claim 1, wherein said exercise using said tool is repetitive exercise,
said exercise amount measuring unit counts the number of times of said repetitive exercise as said exercise amount, and
said output unit outputs said predetermined character or image when said number counted by the said exercise amount measuring unit has reached a predetermined number corresponding to said predetermined exercise amount.

3. A tool as claimed in claim 1, further comprising an accumulated time measuring unit operable to measure an accumulated time after said tool has been first used, wherein
said output unit outputs said predetermined character string or image under a condition where said accumulated time until said exercise amount measured by said exercise amount measuring unit reaches said predetermined exercise amount is equal to less than a predetermined value.

4. A tool as claimed in claim 1, further comprising an accumulated time measuring unit operable to measure an accumulated time that has passed after said tool has been first used, wherein
said data storing unit further stores a plurality of character strings or images to correspond to a plurality of accumulated times, and
said output unit outputs, when said exercise amount measured by said exercise amount measuring unit has reached said predetermined exercise amount, one of said character strings or images corresponding to said accumulated time measured by said accumulated time measuring unit.

5. A tool as claimed in claim 1, further comprising an exercise amount memory operable to store an accumulated exercise amount that is obtained by accumulating the measuring result of said exercise amount measuring unit, while said tool is not used, wherein
said output unit outputs to said predetermined character string or image when a sum of an exercise amount of said user newly detected while said tool is used again and said accumulated exercise amount has reached to said predetermined exercise amount.

6. A tool as claimed in claim 5, wherein said exercise amount memory stores said accumulated exercise amount for each of a plurality of users,
a user identifying information acquiring unit is further provided operable to acquire information identifying each of said plurality of users when said tool is used again, and
said output unit acquires and uses said accumulated exercise amount corresponding to said user identifying information acquired by said user identifying information acquiring unit from said exercise amount memory.

7. A tool as claimed in claim 1, further comprising:
a user information acquiring unit operable to acquire user information related to said user; and
a processing unit operable to process said character string or image by using said user information, wherein
said output unit outputs said character string or image after being processed.

8. A tool as claimed in claim 1, further comprising a user information acquiring unit operable to acquire user information related to said user, wherein
said data storing unit further stores a plurality of character strings or images to correspond to a plurality of units of user information, and
said output unit outputs one of said character strings or images corresponding to said user information acquired by said user information acquiring unit when said exercise amount measured by said exercise amount measuring unit has reached said predetermined exercise amount.

9. A tool as claimed in claim 1, further comprising a user information acquiring unit operable to acquire user information related to said user, wherein
said data storing unit further stores a plurality of character strings or images to correspond to a plurality of predetermined exercise amounts, respectively, and
said output unit outputs, when said exercise amount measured by said exercise amount measuring unit has reached one of said predetermined exercise amounts, one of said character string or images that corresponds to said one of said predetermined exercise amounts.

10. A tool as claimed in claim 1, further comprising:
an identifying information storing unit operable to store tool identifying information that individually identifies said tool; and
a processing unit operable to process said character string or image by using said tool identifying information, wherein
said output unit outputs said character string or image after being processed.

11. A tool as claimed in claim 1, further comprising:
an identifying information acquiring unit operable to acquire tool identifying information for individually identifying said tool from an outside of said tool; and
a processing unit operable to process said character string or image by using said tool identifying information, wherein
said output unit outputs said character string or image after being processed.

12. A point-giving server for giving a user points, comprising:
a data acquiring unit operable to acquire a character string or image;
a converter operable to convert said character string or image acquired by said data acquiring unit to points by using a point converting table which makes said character string or image correspond to said points; and
an output unit operable to output said points generated by said converter to increase points accumulated for said user.

13. A point-giving server as claimed in claim 12, wherein said data acquiring unit acquires a plurality of types of character strings or images, and
said converting table makes combinations of said plurality of types of character strings or images to a plurality of points, respectively, and converts each of said combinations of said plurality of types of character strings or images to corresponding points.

14. A point-giving system having a tool for allowing a user to take exercise and a point-giving server for giving said user points, wherein said tool includes:
an exercise amount measuring unit operable to measure an exercise amount of said user;
a data storing unit operable to store a predetermined character string or image; and
an output unit operable to output said predetermined character string or image stored in said data storing unit when said exercise amount measured by said exercise amount measuring unit has reached a predetermined exercise amount, and
wherein said point-giving server includes:
a data acquiring unit operable to acquire information specifying said predetermined character string or image output by said output unit of said tool;
a converter operable to identify said predetermined character string or image from said information acquired by said data acquiring unit by using a point converting table for making character strings or images to plural points, and to convert said predetermined character string or image to corresponding points; and
an output unit operable to output said points generated by conversion by said converter to increase accumulated points for said user.

15. A point-giving method for giving points to a user who used a tool, comprising:
measuring an exercise amount of said user by said tool and outputting a predetermined character string or image by said tool when said measured exercise amount has reached a predetermined exercise amount; and
acquiring by a point-giving server said predetermined character string or image output by said tool and outputting points corresponding to said predetermined character string or image thus acquired from said point-giving server to increase points accumulated for said user.

16. A program embodied on computer-readable medium, for performing a procedure in accordance with an exercise amount of a user, comprising:
an exercise amount measuring module operable to measure said exercise amount of said user; and
an output module operable to read a predetermined character string or image stored in a data storing unit when said exercise amount thus measured has reached a predetermined exercise amount.

17. A program embodied on computer-readable medium, for performing a point-giving procedure which gives points to a user, comprising:
a data acquiring module operable to acquire a character string or image;
a converting module operable to convert said character string or image acquired by said data acquiring module to points by using a point converting table which makes said character string or image correspond to said points; and
an output module operable to output said points generated by conversion by said converting module to increase points accumulated for said user.
